(19) United States
(12) Patent Application Publication
(10) Pub. No.: US 2019/0393454 A1
(43) Pub. Date: Dec. 26, 2019

(54) ALKALINE BATTERY

(71) Applicant: SAFT, Levallois-Perret (FR)

(72) Inventor: Gerard RIGOBERT, FARGUES St HILAIRE (FR)

(73) Assignee: SAFT, Levallois-Perret (FR)

(21) Appl. No.: 16/464,762

(22) PCT Filed: Dec. 1, 2017
(86) PCT No.: PCT/EP2017/081214

§ 371 Date: May 29, 2019

(30) Foreign Application Priority Data
Dec. 1, 2016 (FR) 1661785

(51) Int. Cl. H01M 2/04; H01M 2/06; H01M 10/30

(52) U.S. Cl. CPC H01M 2/043; H01M 2/06; H01M 2220/10; H01M 2300/0014; H01M 10/30

(57) ABSTRACT

An electromechanical element (1) comprising: a recipient (2) including an aperture allowing at least one set of plates (4) to be inserted; and a cover (3) intended to be assembled on the aperture of the recipient, comprising: i) a first wall (17) including at least one aperture for the passage of a current output terminal (6), this first wall making an angle ranging front 80 to 10° to the horizontal, ii) a second wall (19) making an angle ranging from 5° to 85° to the horizontal, the zone of contact between the recipient and the cover defining a plane of closure (16) of the element, which plane of closure makes an angle ranging from 5° to 85° to the horizontal. The design of the recipient and of the cover allows a plurality of electrochemical elements to be stacked to form a battery (10).

### BACKGROUND OF THE INVENTION

### Field of the invention

The invention relates to the technical field of batteries comprising alkaline-electrolyte electrochemical cells, in particular of the nickel-cadmium type. These electrochemical cells are generally used for stationary applications, in emergency power supplies or for powering industrial plant.

### Background Art

A battery is an electric power generation device having a plurality of electrochemical cells, further referred to as cells in the following, connected in series and/or in parallel by electrical conductors. An alkali electrolyte cell of parallelepipedal format comprises a container of parallelepipedal format provided with an opening enabling the introduction of at least one set of plates, and a cover to be assembled over the opening of the container.

The nickel-cadmium type cells have two current output terminals, further referred to as terminals in the following, which are generally mounted through the upper horizontal surface of the cover. Each terminal protrudes from the cover of the cell by one of its ends. This arrangement of the terminals prevents two cells from being placed one on top of the other. In effect, the terminals need to be accessible to an operator such that the operator can perform the operations of connecting the cells or disconnecting them. However, if the terminals are located on the upper horizontal wall of the cover of the cell and the cells are placed one on top of the other, it becomes impossible to access them.

The structure of a cell of the nickel-cadmium type having a parallelepiped format of the prior art will be better understood with reference to FIGS. 1a, 1b and 1c.

FIG. 1a shows a longitudinal cross-sectional view of a cell according to the prior art before the cover or lid is closed onto the container. The cell 1 comprises a container 2 and a horizontal plane cover 3. One or more sets of plates 4 is introduced into the container. A portion of the upper edge of each plate extends into a plate head 5, which is in fact an extension of the current collector, which extension is not covered with active material. The heads of the plates of the same polarity converge towards the corresponding polarity terminal and are electrically connected thereto. A method of connecting the plate heads to a terminal is described in French Patent 2,418,547. The function of the plate heads is to conduct current from the electrodes to the corresponding terminal 6. In FIG. 1a, only the plate heads of a given polarity are shown. The terminal passes through the cover of the cell. It protrudes considerably from the cell by one of its ends 7, thereby preventing another cell being placed on top of this cell. The set of plates are secured to the cover because they are electrically connected to the terminals which themselves are fixed to the cover. In order to close the cover onto the container, a vertical downward movement of the at least one set of plates is carried out, thereby engaging the cover with the container. Closure of the cover onto the container is generally achieved by welding. The melting of the part of the cover and the part of the container to come into contact with each other is obtained by using, for example, hot plates, a laser or a hot air jet.

FIG. 1b shows the cell after closing the cover onto the container,

FIG. 1c shows a view of the cell of FIG. 1b according to the cross-sectional plane A-A of FIG. 1b. It shows one of the two major lateral faces of the container of the cell. This figure shows the rectangular format of the plates while FIGS. 1a and 1b show only the edge of the plates. It also highlights the presence of the two types of plate head, the plate heads of the positive plates 5a and the plate heads of the negative plates 5b. The positive plate heads 5a are connected to the positive terminal 7a and the negative plate heads 5b are connected to the negative terminal 7b. A filling plug 8 is located between the two terminals. The fill level of the electrolyte is indicated by the line 9. The FIG. 1c shows that the presence of the two terminals and of the electrolyte filling plug on the horizontal upper face of the cover makes it impossible to stack two cells without blocking access to the terminals and to the filling plug.

Since nickel-cadmium cells cannot be stacked, if it is desired to associate a plurality of cells in rows to form a battery, a support comprising shelves of different heights is used, each shelf receiving a row of cells. The height difference between the shelves allows a height offset of the position of the terminals of one row of cells with respect to another row. Such a battery is shown in FIG. 2. The battery 10 comprises a support 11 comprising different shelves 12a, 12b, 12c of different heights. Each shelf receives a row 13 of cells assembled side by side and electrically connected to each other. The use of such a support results in a loss of space for the user. In effect, the volume under each shelf is lost. In addition, since each shelf has a width at least equal to that of a cell, such a support makes for a large footprint.

Alkaline electrolyte cells having terminals on a vertical wall of the cell have been designed, thereby solving the problem of the loss of space on the ground surface. Mention may be made of European Patent Application EP-A-2,728,641. This document discloses in FIG. 10C an alkaline electrolyte cell of parallelepipedal format. The cover is in the form of a vertical plate forming one of the two major faces of the parallelepiped. The two terminals are housed through this vertical plate. The cell is closed by welding the vertical plate to the container of the cell. Electrolyte filling is performed through a fill port disposed on the upper horizontal surface of the container. In this configuration, two cells can be assembled side by side and connected together. However, the weld region is in contact with the electrolyte. Now, there is still a risk of electrolyte leakage through a weld area. This configuration therefore does not solve the problem of the existence of contact between the weld area and the electrolyte.

As a result, there is a need for an alkali-electrolyte cell that can be placed on top of another cell and in which the region of contact between the cover of the cell and the container of the cell is not exposed to the electrolyte.

Also, there is a need to be able to arrange several rows of cells placed side by side on a same horizontal plane without losing space between these rows.

There is also a need for a cell, the cover of which has a shape allowing access to the foot of the terminal. The foot of the terminal is the end of the terminal inside the cell when the cover is assembled onto the container.

Finally, a cell is sought, the cover and the container of which have a shape that makes it possible to close the cover onto the container of the cell by a conventional method, that is to say involving a vertical downward movement of the one or more sets of plates in the container of the cell, as explained above with reference to FIG. 1a.

### SUMMARY OF THE INVENTION

To this end, the invention provides an electrochemical cell comprising:

a container having an opening for introducing at least one set of plates;

a cover intended to be assembled over the opening of the container, comprising:

i) a first wall having at least one opening for the passage of a current output terminal, said first wall making an angle of from 80° to 110° with respect to the horizontal,

ii) a second wall making an angle of from 5° to 85° with respect to the horizontal,

the region of contact between the container and the cover defining a closure plane of the cell, wherein the closure plane makes an angle ranging from 5° to 85° with respect to the horizontal.

In one embodiment, the container contains an electrolyte and said electrolyte is not in contact with the region of contact between the container and the cover.

In one embodiment, the second wall makes an angle ranging from 30° to 70°, preferably from 40 to 70°, more preferably from 40 to 50° with respect to the horizontal.

In one embodiment, the first wall has two openings each allowing the passage of a current output terminal.

In one embodiment, the second wall has a first edge adapted to be brought into contact with the container and a second edge which is continuous with the first wall.

In one embodiment, the cover has at least one horizontal wall having a filling plug for electrolyte.

In one embodiment, a portion of the horizontal wall has a recess in which the electrolyte filling plug is housed.

According to one embodiment, the electrochemical cell comprises an alkaline electrolyte, for example of the nickel-cadmium type.

The invention also provides a battery comprising at least two electrochemical cells stacked one on top of the other, each cell being as defined above, the cells resting on a support structure.

The invention also provides a method for manufacturing an electrochemical cell comprising the steps of:

a) providing a container having an opening for introducing at least one set of plates;

b) providing a cover intended to be assembled over the opening of the container, said cover comprising:
i) a first wall comprising at least one opening for the passage of a current output terminal, said first wall making an angle ranging from 80° to 110 with respect to the horizontal,
ii) a second wall making an angle of from 5° to 85° with respect to the horizontal,

the region of contact between the container and the cover defining a closure plane of the cell, the closure plane making an angle of 5° to 85° with respect to the horizontal;

c) fixing two current output terminals through the first wall of the cover, the current terminals themselves being mechanically and electrically connected to a set of plates;

d) inserting the one or more sets of plates into the container;

e) engaging the cover onto the container;

f) closing the electrochemical cell;

g) optionally filling the container with an electrolyte through an opening on the cover.

In one embodiment, the closure of the container is performed by welding.

In one embodiment, the introduction of the one or more sets of plates into the container is accomplished by a downward vertical movement.

In one embodiment, the electrochemical cell fabricated by the method is the cell as defined above.

### BRIEF DESCRIPTION OF THE DRAWINGS

FIG. 1a shows a longitudinal sectional view of a cell according to the prior art before the cover is closed onto the container.

FIG. 1b shows a longitudinal cross-sectional view of a cell according to prior art after closing the cover onto the container.

FIG. 1c is a view of the cell according to the prior art according to cross-sectional plane A-A of FIG. 1b.

FIG. 2 is a perspective view of a battery comprising:

A plurality of rows of cells according to the prior art, a support comprising shelves, each row of cells being arranged on a shelf of the support.

FIG. 3a shows a longitudinal sectional view of a cell according to the invention, before the cover is closed onto the container.

FIG. 3b shows a longitudinal sectional view of a cell according to the invention, after closing the cover onto the container.

FIG. 3c shows a view of the cell according to the invention taken along the cross-sectional plane A-A of FIG. 3b.

FIG. 4 shows a longitudinal sectional view of a cell according to the invention, the cover of which is provided with a recess receiving an electrolyte filling plug.

FIG. 5 shows a stack of cells according to the invention. The lower level and the upper level of the stack each receive two rows of cells, each row being constituted by an assembly of cells side-by-side.

FIG. 6 shows a stack of two rows of cells according to the invention, electrically connected to one another.

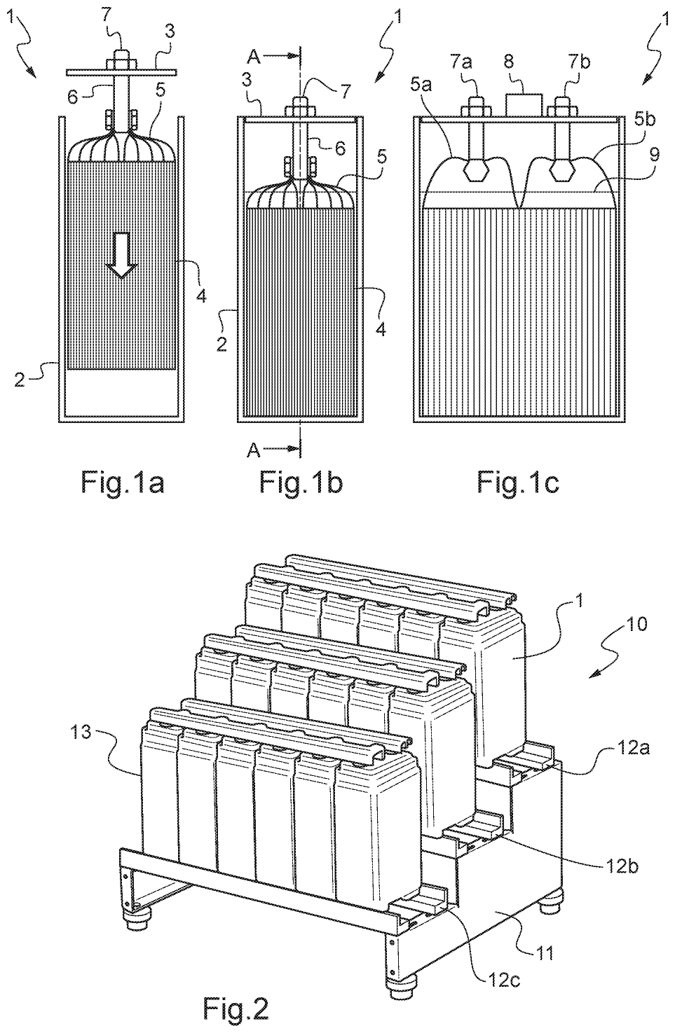

### DETAILED DESCRIPTION OF EMBODIMENTS

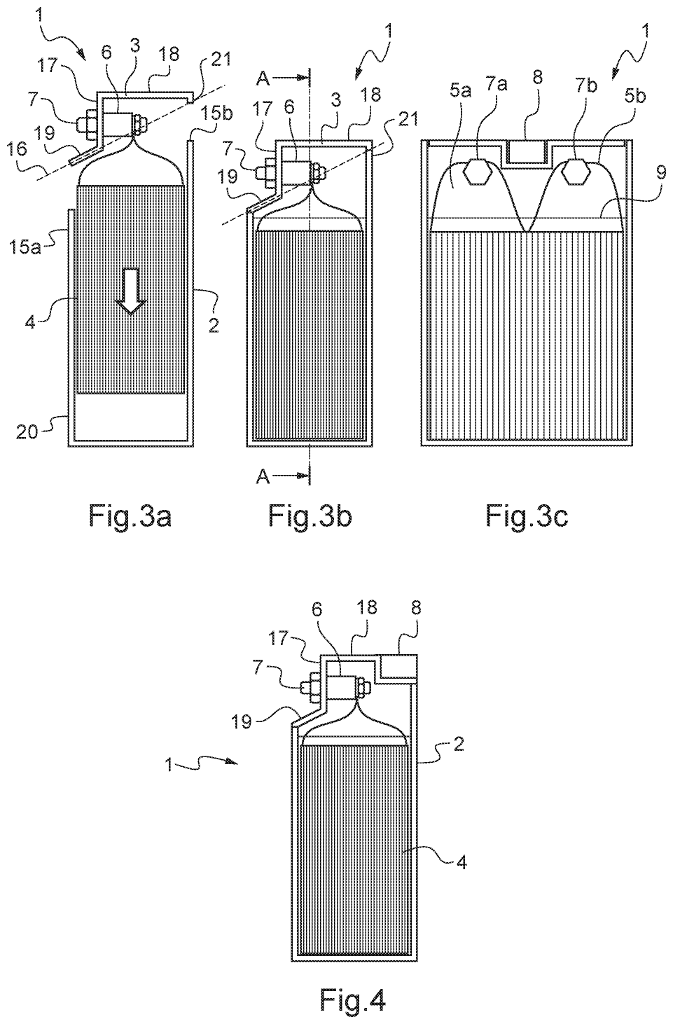

The cell according to the invention is characterized by a particular shape of cover and container. The shape of the cover and that of the container will be explained in relation to FIG. 3a.

FIG. 3a shows a longitudinal sectional view of a cell 1 before closing the cover 3 onto the container 2. The container is generally parallelepiped in shape. It has an opening that is large enough to allow introduction of one or more sets of plates 4. Two of the vertical walls of the container, generally the larger vertical walls of the container, have different heights 15a, 15b. This height difference makes it possible to create an inclined closure plane 16 of the cover onto the container. The term “inclined closure plane” should be taken to mean a closure plane which makes an angle of between 5 and 85° with respect to the horizontal. For a given depth of container, the angle of the closure plane can be varied in the range of 5 to 85°, by changing the height difference between the two vertical walls.

The cover 3 has an opening, the shape of which is complementary to that of the opening of the container. The cover has a first wall 17 making an angle of 80-110° with respect to the horizontal. Typically, the first wall is vertical. It includes at least one opening for the passage of a terminal 6. Generally, it includes two openings, one for the passage of the positive terminal and the other for the passage of the negative terminal. The two terminals overlap according to the views of FIGS. 3a and 3b but are visible in FIG. 3c. This first wall 17 is in continuity with a horizontal wall 18.

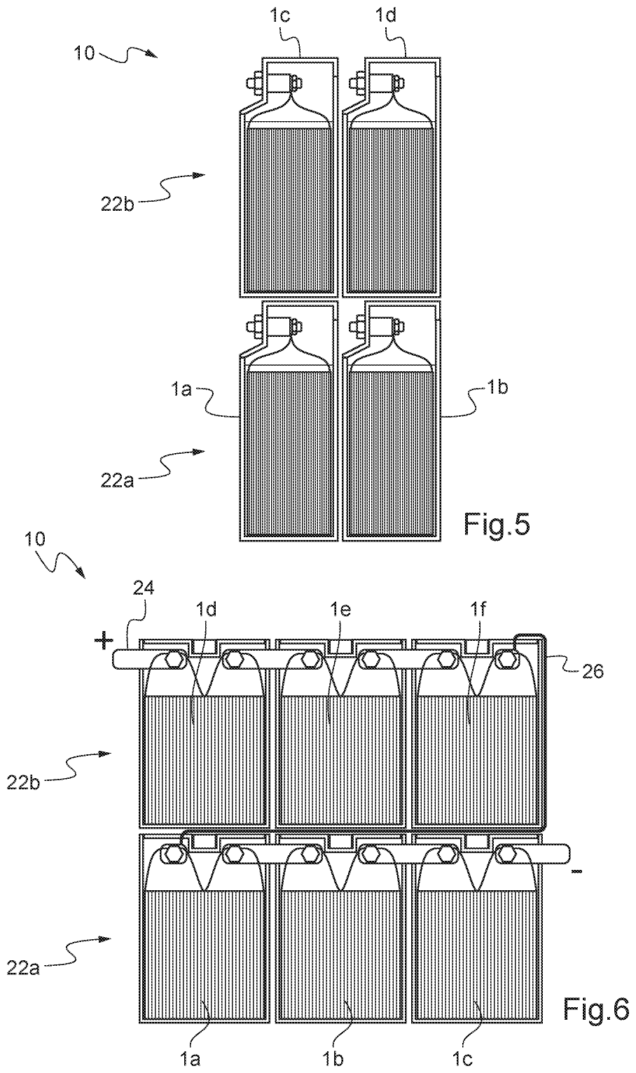

The cover has a second wail 19 in continuity with the first wall 17. This second wall makes an angle of 5° to 85° with respect to the horizontal. This angle is the same as the angle of the closure plane defined above for the container. The presence of the second inclined wall makes it possible to recess vertical wall 17 of the cover with respect to vertical wall 20 of the container. This recess creates an available space for receiving the end 7 of the terminals outside the cell. A person skilled in the art knows how to calculate for a given length of terminal protruding from the cell, the length and the inclination of the second wall. Thanks to this second inclined wall, the footprint occupied by a battery made up by a plurality of cells placed one against the other corresponds only to the surface area occupied by the containers of said cells. FIG. 5 highlights this advantage.

The angle of the closure plane may be adjusted to facilitate access to the foot of the terminal. If it is too small, it is possible that it becomes difficult to access the foot of the terminal by an operator or by a tool. If it is too high, the cover may have a height that is too large, thereby penalizing the volume capacity of the cell. As shown in FIG. 3a, the inner volume of the cover is occupied by a portion of the terminal and the plate heads once brought together. However, these two components do not participate in the generation of electric current. Consequently, an angle of the closure plane ranging from 30° to 70° will be generally chosen, preferably 40 to 70°, more preferably 40 to 50° with respect to the horizontal.

The cover has a third wall 21 on a side opposite the first wall 17. The height of this third wall is determined by extending the closure plane 16 until it intersects the third wall.

The at least one set of plates 4 are integral with cover 3 since the at least one set of plates are electrically connected to the terminals 6 which themselves are fixed through the cover. In order to close the cover onto the container, the one or more sets of plates are introduced into the container and by exerting a vertical downward movement schematized by an arrow in FIG. 3a, the cover is brought into contact with the container. Closure of the cover onto the container is generally achieved by welding. The melting of the portion of the cover and the portion of the container designed to come into contact one with the other is obtained by using, for example, hot plates, a laser or a hot air jet. Thus, the conventional method for closing a nickel-cadmium type cell can be maintained.

FIG. 3b shows the cell after closing the cover onto the container,

FIG. 3c shows a view of the cell shown in FIG. 3b according to the cross-sectional plane A-A of FIG. 3b. FIG. 3c is a view of one of the two larger lateral faces of the cell. This view shows the rectangular format of the plates while FIGS. 3a and 3b only show the edge of the plates. This view also shows two types of plate head, the plate heads of the positive plates 5a and the plate heads of the negative plates 5b. The positive plate heads 5a are connected to the positive terminal 7a and the negative plate heads 5b are connected to the negative terminal 7b. Since the terminals are located on a vertical face of the cover, the upper horizontal surface of the terminal-free cover can be advantageously occupied by an electrolyte filling plug 8. The plug may be located between the positive and negative plate heads 5a, 5b, in a recess of the cover, as shown in FIG. 3c. In order to reduce the risks of electrolyte leakage through a weld zone, the electrolyte level is located below the region of contact between the container and the cover. The electrolyte level is embodied by the line 9. It is located under the region of contact between the inclined wall 19 of the cover and the wall of the container 2.

FIG. 3c shows the almost flat surface of the horizontal upper part of the cover, thereby enabling the cells to be stacked.

In one embodiment, the recess housing the filling plug is proximate to the vertical wall opposite that receiving the terminals, as illustrated in FIG. 4. This embodiment makes access to the filling plug easier than when the latter is located in proximity to the center of the cover, as is the case in the embodiment of FIG. 3c.

The material used for manufacturing the container and cover is a material commonly used in alkaline electrolyte cell technology. Preferably, it is a plastic material.

The invention makes it possible to eliminate the lost volume between the cells, which was occupied in the prior art by the terminals. This advantage is illustrated in FIG. 5. The latter shows a battery 10 comprising a stack of cells 1a, 1b, 1c, 1d according to the invention. The lower level of the stack comprises a row 22a of two cells arranged side by side 1a, 1b. Similarly, the top level of the stack includes a row 22b of two cells arranged side by side 1c, 1d. It is seen that the cells are stacked one on top of the other, without loss of space between them, neither in the vertical direction nor in the horizontal direction. Therefore, compactness of the battery is improved.

FIG. 6 shows a battery 10 comprising a stack of two rows 22a, 22b of cells 1a-1f according to the invention. The cells of each row are electrically connected to each other by heavy cross-section metal bars 24. The upper row of cells is electrically connected to the lower row of cells by an electrical conductor 26. The operator has easy access to the terminals and no space is lost between the cells. This figure therefore demonstrates the advantage of positioning the terminals on a vertical face of the cover of the cells.

1. An electrochemical cell comprising:
a container having an opening for introducing at least one set of plates;
a cover intended to be assembled over the opening of the container, comprising:
i) a first wall having at least one opening for the passage of a current output terminal, said first wall making an angle of from 80° to 110° with respect to the horizontal,
ii) a second wall making an angle of from 5° to 85° with respect to the horizontal,
the region of contact between the container and the cover defining a closure plane of the cell, wherein the closure plane makes an angle ranging from 5° to 85° with respect to the horizontal.

2. The electrochemical cell according to claim 1, wherein the container contains an electrolyte and said electrolyte is not in contact with the region of contact between the container and the cover.

3. The electrochemical cell according to claim 1, wherein the second wall makes an angle ranging from 30° to 70° with respect to the horizontal.

4. The electrochemical cell according to claim 1, wherein the first wall has two openings each allowing the passage of a current output terminal.

5. The electrochemical cell according to claim 1, wherein the second wall has a first edge adapted to be brought into contact with the container and a second edge which is continuous with the first wall.

6. The electrochemical cell according to claim 1, wherein the cover has at least one horizontal wall having a filling plug for electrolyte.

7. The electrochemical cell according to claim 6, wherein a portion of the horizontal wall has a recess in which the electrolyte filling plug is housed.

8. The electrochemical cell according to claim 1, comprising an alkaline electrolyte.

9. The electrochemical cell according to claim 8, of the nickel-cadmium-type.

10. A battery comprising at least two electrochemical cells placed one on top of the other, each cell being as defined in claim 1, the cells resting on a support structure.

11. A method of manufacturing an electrochemical cell comprising the steps of:
a) providing a container having an opening for introducing at least one set of plates;
b) providing a cover intended to be assembled over the opening of the container, said cover comprising:
i) a first wall comprising at least one opening for the passage of a current output terminal, said first wall making an angle ranging from 80° to 110 with respect to the horizontal,
ii) a second wall making an angle of from 5° to 85° with respect to the horizontal,
the region of contact between the container and the cover defining a closure plane of the cell, the closure plane making an angle of 5° to 85° with respect to the horizontal;
c) fixing two current output terminals through the first wall of the cover, the current output terminals themselves being mechanically and electrically connected to a set of plates;
d) introducing the one or more sets of plates into the container;
e) engaging the cover onto the container;
f) closing the electrochemical cell;
g) optionally filling the container with an electrolyte through an orifice located on the cover.

12. The method of claim 11, wherein the container closure is carried out by welding.

13. The method according to claim 11, wherein the introduction of the one or more sets of plates into the container is performed by a downward vertical movement.

14. The method according to claim 11, wherein the cell comprises a container having an opening for introducing at least one set of plates; a cover intended to be assembled over the opening of the container, comprising:
i) a first wall having at least one opening for the passage of a current output terminal, said first wall making an angle of from 80° to 110° with respect to the horizontal,
ii) a second wall making an angle of from 5° to 85° with respect to the horizontal,
the region of contact between the container and the cover defining a closure plane of the cell, wherein the closure plane makes an angle ranging from 5° to 85° with respect to the horizontal.

15. The method according to claim 11, including the step of selecting an angle of said closure plane that allows ready access to a foot of the two current output terminals by an operator or by a tool prior to closure of the cell.

16. The electrochemical cell according to claim 1, wherein the angle of the closure plane allows access to a foot of the terminal.

17. The electrochemical cell according to claim 1, wherein the second wall makes an angle ranging from 40° to 70° with respect to the horizontal.

18. The electrochemical cell according to claim 1, wherein the second wall makes an angle ranging from 40° to 50° with respect to the horizontal.
